(19) United States
(12) Patent Application Publication
(10) Pub. No.: US 2026/0306957 A1
(43) Pub. Date: Oct. 8, 2026

(54) INTERLOCKING BUILDING BLOCK FOR HOLDING A WHEEL

(71) Applicant: DOUBLEEAGLE INDUSTRY (CHINA) LIMITED, Shantou City (CN)

(72) Inventor: Dunhua Yang, Shenzhen (CN)

(21) Appl. No.: 19/564,078

(22) Filed: Mar. 11, 2026

(30) Foreign Application Priority Data
Apr. 3, 2025 (CN) 202510417004.8

(51) Int. Cl. A63H 17/26; A63H 17/00

(52) U.S. Cl. CPC A63H 17/262; A63H 17/002

(57) ABSTRACT

Disclosed is an interlocking building block for holding a wheel in an interlocking building block model, comprising: a hub flange rotatable about a rotational axis with a front side as seen in the direction of the rotational axis and a rear side opposite the front side, wherein on the front side, radially spaced from the rotational axis, at least two form-fit elements acting in the circumferential direction about the rotational axis for transmitting a torque acting about the rotational axis to the wheel are held, and a hub pin held on the rear side concentrically to the rotational axis on the hub flange for mounting the hub flange on a wheel suspension, characterized by a bearing element independent of the form-fit elements for axially holding a retaining means which is configured to block an axial movement between the wheel and the hub flange.

### TECHNICAL FIELD

The present invention relates to an interlocking building block.

### BACKGROUND

Such an interlocking building block is offered by the company Lego under the designation “Technic, Steering Wheel Hub 3 Pin Holes Round” with part number 35189.

### SUMMARY

It is the object of the invention to improve the known interlocking building block.

The object is achieved by the features of the independent claims. Preferred further developments are the subject matter of the dependent claims.

Starting from an interlocking building block for holding a wheel in an interlocking building block model with a hub flange rotatable about a rotational axis having a front side as seen in the direction of the rotational axis and a rear side opposite the front side, wherein on the front side radially spaced from the rotational axis at least two form-fit elements acting in the circumferential direction about the rotational axis for transmitting a torque acting about the rotational axis to the wheel are held, and with a hub pin held on the rear side concentrically to the rotational axis on the hub flange for mounting the hub flange on a wheel suspension, an interlocking building block according to the invention comprises a bearing element independent of the form-fit elements for axially holding a retaining means which is configured to block an axial movement between the wheel and the hub flange.

The stated interlocking building block is based on the consideration that the conventional interlocking building block provides form-fit elements acting about the rotational axis for transmitting a torque to the wheel, which at the same time also assume the axial securing of the wheel relative to the hub flange. This dual function, however, places high demands on the dimensional accuracy and the insertion accuracy of the form-fit elements. Even minor tolerance deviations can lead to an overdetermined positional guidance, as a result of which mechanical stresses arise during assembly of the model or the components cant during joining. In practice, this can lead to the wheel being attachable to the hub only with increased force or, in the worst case, not being mountable correctly at all.

Here the stated interlocking building block addresses the consideration of separating the function of torque transmission and the function of axial fixation from one another in terms of construction. While the form-fit elements acting about the rotational axis continue to serve the form-fit transmission of a torque between the wheel and the hub flange, the axially directed holding function is provided by a separate bearing element acting independently of the form-fit elements. This bearing element is formed for receiving a retaining means – preferably an axial fixing pin – which secures the wheel against a movement along the rotational axis.

In this way, the form-fit elements provided for torque transmission are relieved of the requirement to simultaneously ensure a play-free axial locking. This allows the form-fit elements to be manufactured with larger tolerances, which not only reduces manufacturing effort but in particular also facilitates assembly. The risk of canting or stressing during insertion of several simultaneously acting form-fit elements is reduced. The interlocking building block model can thus be assembled with less force, is less susceptible to manufacturing tolerances, and overall exhibits a more robust and repeatable assembly behavior. Furthermore, the clear functional separation enables easier disassembly of individual components as well as improved modularity in the construction of complex interlocking building block models.

In a further development of the stated interlocking building block, the bearing element is formed as a pin receptacle for receiving the retaining means in the form of a securing pin from the front side toward the rear side. In this way, the retaining means can be inserted from the side facing the user, whereby a particularly assembly-friendly and easily accessible connection is created. The use of a securing pin as a retaining means offers several constructive and functional advantages compared to alternative fastening mechanisms, such as screws or snap connections.

On the one hand, a securing pin generally does not require a rotational movement for insertion, which is advantageous in particular in confined installation spaces or at difficult-to-access assembly locations. This simplifies manual handling and reduces the force and coordination effort during assembly. Furthermore, a securing pin can be inserted by purely linear movement and – depending on the configuration – can be removed again just as easily, whereby a releasable and reusable connection results without tools being required.

Another advantage lies in the fact that securing pins can be realized in various embodiments, such as a pluggable pin, as an element with form-fit locking by transverse projections or tongue-and-groove engagement, as a bayonet-like element, or as a spring-elastically held locking element. This design freedom makes it possible to adapt the degree of holding force, the ability to disassemble, as well as the play between the components to the respective application without impairing the geometric or functional uniformity of the overall system.

The use of a securing pin as a separate axial securing means thus permits a constructively simple, tolerance-insensitive and user-friendly solution for the axial fixation of the wheel on the hub flange, irrespective of which specific mode of operation – for example plug-in, clamping, snap or rotational locking – underlies the pin.

In an additional further development of the stated interlocking building block, the pin receptacle has, at an end directed toward the rear side, a retaining shoulder on which axially acting locking elements of the securing pin can be supported. In this way, a purely form-fit axial fixation between the securing pin and the pin receptacle can be realized without elastic preload or frictional holding force being required.

The use of a form-fit locking in particular brings the advantage that the connection functions reliably independently of material rigidities, clamping forces or manufacturing tolerances. In contrast to frictional or spring-loaded locking mechanisms, which can lose holding force under prolonged loading, material fatigue or repeated assembly, a form-fit locking remains stable over the long term and free of play, provided that the geometric mating surfaces are defined accordingly.

Moreover, with such a retaining shoulder the direction of force can be guided clearly: a load acting in tension in the axial direction – for example when pulling or when laterally twisting the wheel during play operation – is mechanically absorbed via the support of the locking element on the shoulder and is not held by the shear strength of a pin or by clamping friction. As a result, the component loading is distributed over predictable contact surfaces and is not concentrated at specific points, which benefits the long-term durability and the safety of the connection.

A further advantage is the constructive clarity: the locking function is clearly assigned to a geometric surface (the retaining shoulder), whereby assembly, disassembly and possibly also automatic locking during snap-in or insertion movements can be realized more easily. This defined support surface furthermore enables a precise limitation of axial play and promotes the development of play-free assemblies.

In a further development of the stated interlocking building block, the locking element is formed as a bayonet lug that can be axially supported on the retaining shoulder, wherein the pin receptacle has a bayonet groove for guiding the bayonet lug. In this way, a radially and axially form-fit connection is created which dispenses with spring-loaded or elastically deformable elements.

Dispensing with spring-loaded hooks or snap connections increases the structural rigidity of the connection, in particular in the radial direction, and allows an exact, defined positioning of the securing pin within the pin receptacle. The locking does not take place by material deformation, but exclusively by guiding and supporting fixed geometries – namely the bayonet lug along the bayonet groove and its support on an axial retaining surface.

As a result, the connection is insensitive to aging, material fatigue or temperature changes which could lead to a loss of function in elastic elements. In addition, the bayonet connection enables rapid, tool-free assembly with simultaneously high functional reliability and repeat accuracy. The rotational movement for engagement can be mechanically guided, limited and controlled, which is advantageous in particular in modular or automated assemblies.

Furthermore, by designing the bayonet groove the extent of the engagement rotation and the locking direction can be clearly defined, which supports the avoidance of assembly errors and intuitive user guidance. The axial play can also be precisely adjusted by the geometry of the lug and the shoulder, which leads to a play-free and load-bearing connection that is permanently highly loadable.

In another further development of the stated interlocking building block, the pin receptacle is formed in sections in a tubular manner with a radial window in the region of the retaining shoulder. In this way, visibility of the locking element, in particular of the bayonet lug, is enabled during insertion and rotation of the securing pin, which facilitates and supports the assembly of the interlocking building block model.

The radial window serves as a visual control device by means of which the user can directly recognize the correct seat and the complete locking of the retaining means. This is particularly advantageous when the pin receptacle is integrated deeply into an assembly or the retaining shoulder is located in a region that is not fully visible. Through the viewing window it can be checked whether the bayonet lug is fully supported on the retaining shoulder and is located in the end position of the bayonet groove.

In addition, the window can also function as an assembly aid: during insertion of the securing pin, it can be recognized on the basis of the visibility of the locking geometry or on the basis of alignment markings when the rotational movement has been completed and the form-fit locking has correctly engaged. This reduces the risk of incomplete assembly, increases user-friendliness and improves the repeatability of the assembly process.

Depending on the configuration, the radial window can moreover be used for functional monitoring in moving models, for example for checking whether the securing pin has loosened under load or is located in the intended position. Through the combination of visual inspection and mechanical guidance, a functional as well as assembly-practical improvement is thus achieved.

In yet another further development of the stated interlocking building block, the bearing element is arranged concentrically to the rotational axis. In this way, the retaining means can not only be used for axial fixation of the wheel relative to the hub flange, but can simultaneously ensure radial centering between the wheel and the hub.

The concentric arrangement of the bearing element makes it possible to guide the securing pin in a central axis bore, whereby the wheel automatically aligns with respect to the rotational axis during assembly. This measure contributes to avoiding imbalance or alignment errors in the assembled state and promotes the smooth running of the rotating component, which is advantageous both for realistic model functions and for the service life of adjacent connecting elements.

Furthermore, due to the position of the bearing element in the center, a symmetrical force distribution along the axis arises, whereby axial and radial load paths can be better separated and defined. This increases the structural integrity of the assembly under dynamic loading and simplifies, in terms of construction, the design of bearing and connecting elements.

In particular in applications with rotatable components – such as rotating wheels in vehicle models – the concentric position of the securing element improves the running properties and enables a constructively clean coupling to intended rotational axes or shafts. The simultaneous centering and fixation via a common, coaxial element reduces the installation space and the number of individual parts and thus contributes to a compact, function-integrated design.

According to a further aspect of the invention, an interlocking building block for blocking an axial movement between a wheel and a hub flange rotatable about a rotational axis of one of the interlocking building blocks already explained comprises a shaft alignable parallel to the rotational axis with a first end and a second end opposite the first end, a first axially acting form-fit element formed at the first end for blocking the axial movement of the wheel relative to the shaft, and a second axially acting and radially rigid form-fit element formed at the second end for blocking the axial movement of the shaft relative to the hub flange.

The stated interlocking building block is based on the consideration that in conventional systems – such as in the LEGO Technic construction kit – predominantly spring-loaded snap connections, clamping effects or elastically acting coupling elements are used for fixing rotating components. Although these solutions are simple in handling, they are based on frictional engagement or elastic preload and therefore provide no defined locking geometry. In particular in the case of frequent assembly and disassembly, under thermal influences or in larger models, the holding force of such connections can decrease. Moreover, these solutions lack a clear guidance and fixation of the component in the radial direction, which can lead to undesired play, uneven running or twisting.

Here the stated interlocking building block addresses this by proposing to provide the axial locking of the wheel relative to the hub flange via a two-part acting form-fit element formed on both sides of a central shaft. The first form-fit element at the front end acts directly on the wheel and prevents its axial movement in the direction of the hub flange. The second form-fit element at the rear end, by contrast, is designed such that it can engage in a correspondingly formed counterstructure of the hub flange – for example a bayonet groove or a front-side receptacle. This second form-fit element is formed radially rigid, that is, it locks in a form-fit manner without elastic compliance, and is designed such that it permanently and reliably withstands axial forces without being dependent on spring action or material stress.

In this way, a double-sided form-fit, fully mechanically defined locking unit is created, in which both the wheel and the hub flange are fixed relative to one another against an axial movement. The use of a radially rigid, rotationally lockable form-fit element – as realized for example in a bayonet locking principle – represents a novel element in the field of interlocking building block mechanics which, in particular compared with the snapping or clamping connections known from the prior art, offers higher repeat accuracy, durability and freedom from play. At the same time, the configuration allows intuitive and rapid assembly by simple insertion and rotation, without elastic forces having to be overcome. Thus, the interlocking building block opens up a new class of robust, mechanically clearly defined connections in interlocking building block model construction.

In a further development of the stated interlocking building block, the shaft is formed as a hollow shaft with form-fit elements acting in the circumferential direction and held therein. In this way, the form-fit elements can be used multiple times functionally: on the one hand, they serve as a rotational aid during the locking process – for example within the framework of a bayonet connection – on the other hand, they function as radially projecting structures which can interact in a force-fit or form-fit manner with corresponding receptacles of other interlocking building blocks.

By forming the hollow shaft with circumferential form-fit elements – for example in the form of webs, lugs or ribs – a user can securely grip the retaining means during assembly and rotate it in a targeted manner. This facilitates handling particularly in small-format or partially concealed assemblies and reduces the risk of improper insertion. At the same time, the retaining means can be seamlessly integrated into existing interlocking building block systems by means of its external geometry: the radial projections can be designed such that they engage in standardized receptacle holes, clamping bushings or clips of other building blocks, whereby additional mechanical connections are created.

This multiple functionality allows further integration of the securing element into the building structure – for example as a combined retaining pin and connecting element – and thus contributes to increased modularity and constructive flexibility. Furthermore, by targeted design of the circumferential elements, a defined assembly rotation angle can be realized which serves not only as a mechanical limitation but also signals a tactually perceptible end position, whereby operability is additionally improved.

In a particular further development of the stated interlocking building block, the shaft has, toward the second end and below the first axially acting form-fit element, a stop shoulder. In this way, a spatially clearly defined separation point between two components is created – in particular between the wheel guided on the shaft and the hub flange arranged at the opposite end.

The stop shoulder forms an axial positioning surface against which the wheel is supported during assembly and thus serves as a reference stop for its final installation position on the shaft. At the same time, it mechanically and functionally separates the wheel from the section of the shaft located below it, which is provided for locking in the region of the hub flange. Through this stepped configuration, the wheel can be guided in a targeted manner during assembly up to the shoulder without coming into conflict with the locking geometry at the second end.

This constructive measure enables a two-stage assembly guidance: first, the wheel is pushed axially onto the shaft until it rests against the stop shoulder, wherein the first form-fit element blocks its movement forward. Subsequently, the rear section of the shaft – in particular the second axially acting form-fit element – can be inserted independently thereof into a corresponding receptacle of the hub flange and locked there.

Through this functional decoupling of both ends of the shaft, wheel and hub can be joined and positioned independently of one another, which facilitates assembly, reduces tolerance problems and in particular minimizes component loading in the case of repeated disassembly. In addition, by means of the shoulder a defined dimension for the axial position of the wheel can be established, which in turn contributes to uniform running behavior and a precise fit in the overall assembly.

According to a further aspect of the invention, an interlocking building block model comprises a vehicle chassis on which a wheel bearing is held, wherein on the wheel bearing a first of the stated interlocking building blocks is held and wherein on this interlocking building block a wheel is held and axially fixed by means of a further of the stated interlocking building blocks.

### BRIEF DESCRIPTION OF FIGURES

The properties, features and advantages of this invention described above as well as the manner in which these are achieved become more understandable in connection with the following description of the exemplary embodiments, which are explained in more detail in connection with the drawing. Shown are:

FIG. 1 a view of an incompletely assembled interlocking building block model,

FIG. 2a an exploded view of a wheel bearing and a wheel attachable thereto,

FIG. 2b the wheel bearing and the wheel attached thereto of FIG. 2a in a sectional view,

FIG. 3 in a perspective view a hub flange in the wheel bearing of FIGS. 2a and 2b,

FIG. 4a the wheel of FIGS. 2b and 2b from a first perspective, and

FIG. 4b the wheel of FIGS. 2b and 2b from a second perspective.

In the figures, identical technical elements are provided with identical reference signs and are described only once. The figures are purely schematic and in particular do not reproduce the actual geometric proportions.

### LIST OF REFERENCE SIGNS

2 Interlocking building block model / vehicle model

4 Longitudinal direction

6 Transverse direction

8 Height direction

10 Interlocking building block

12 Chassis

13 Wheel

14 Wheel axle

16 Front light

18 Rear light

20 Brake light

22 Wheel assembly

23 First interlocking building block with hub flange

24 Hub flange

26 Rotational axis

28 Receptacle opening (in the hub flange for torque transmission)

30 Brake disc

32 Pin receptacle

34 Bayonet groove

38 Receptacle tube

40 Universal joint partner

42 Bearing opening

44 Wheel bearing

46 Ball joint receptacle

48 Force transmission element

50 Brake caliper

52 Wheel rim

54 Cover plate

56 Torque transmission pin

58 Securing pin

59 Hollow tube (part of the securing pin)

60 Bayonet lug

62 Fixing flange

64 Central receptacle opening

66 Retaining shoulder

68 Radial window

70 Tool receptacle (form-fit elements in the hollow tube)

### DETAILED DESCRIPTION

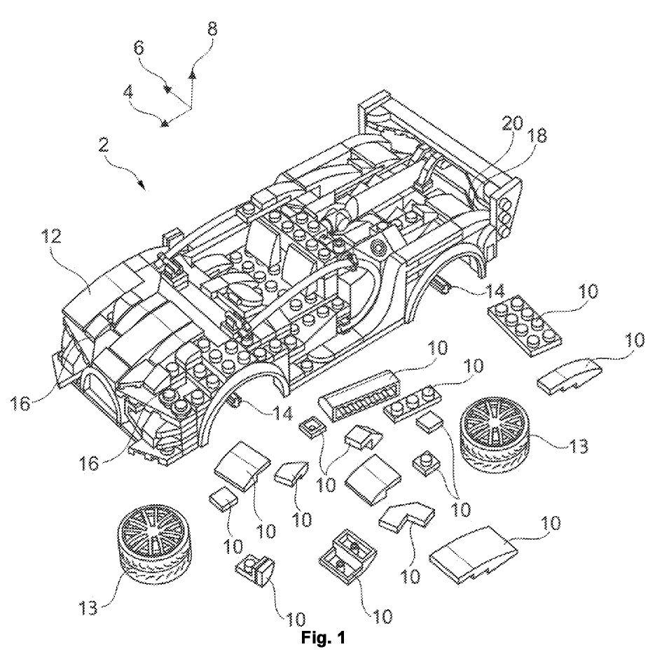

Reference is made to FIG. 1, which shows a view of an interlocking building block model 2 that has not yet been completely assembled.

In the illustrated embodiment, the interlocking building block model 2 is formed as a vehicle movable in a longitudinal direction 4, which extends in the longitudinal direction 4, a transverse direction 6 (transverse to the longitudinal direction 4) and a height direction 8 (transverse to the longitudinal direction 4 and to the transverse direction 6).

The vehicle shown consists of a plurality of interlocking building blocks 10, which in FIG. 1 are not all individually referenced for reasons of clarity. Each interlocking building block 10 is formed as a reusable element for the modular and scalable construction of the interlocking building block model 2. The building blocks 10 follow a standardized grid dimension which ensures a seamless connection of building blocks of different sizes and shapes. The connection takes place by a mechanical clamping principle in which projections not further referenced – such as knobs or pins – are pressed into complementary recesses, likewise not further referenced, whereby a stable but releasable connection is created. This modular construction allows virtually unlimited combination possibilities so that the building blocks 10 can be flexibly assembled, separated and reused.

The vehicle shown in FIG. 1 serves merely as an exemplary embodiment of the interlocking building block model 2 and is therefore explained below only in its essential elements. It comprises a chassis 12 which is supported in a drivable manner on wheels. In the assembly state according to FIG. 1, the wheel axles 14 are already mounted, but the wheels 13 are not yet attached. On the front side of the vehicle as seen in the longitudinal direction 4, building blocks are provided which in the assembled state function as front lights 16. In an analogous manner, on the rear end side of the vehicle building blocks are provided which in the final state form rear lights 18 as well as brake lights 20.

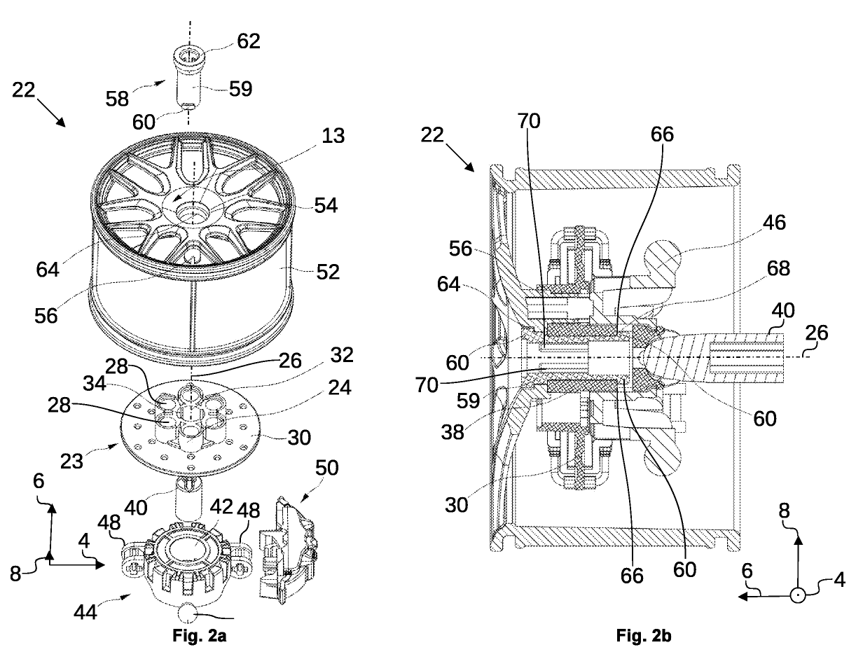

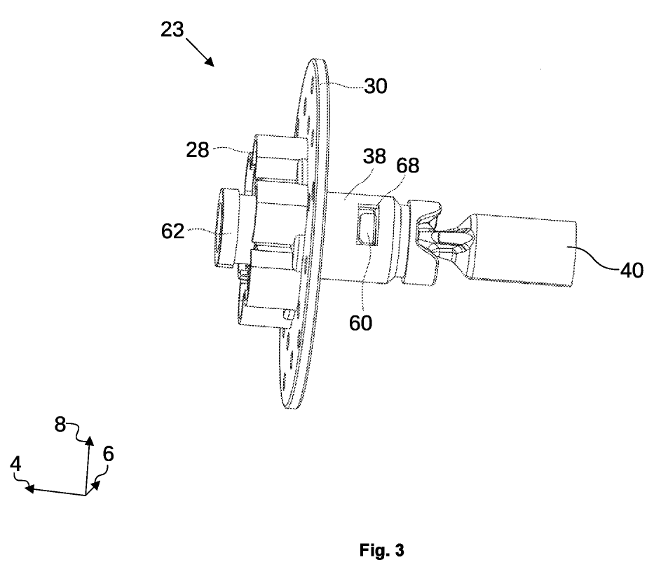

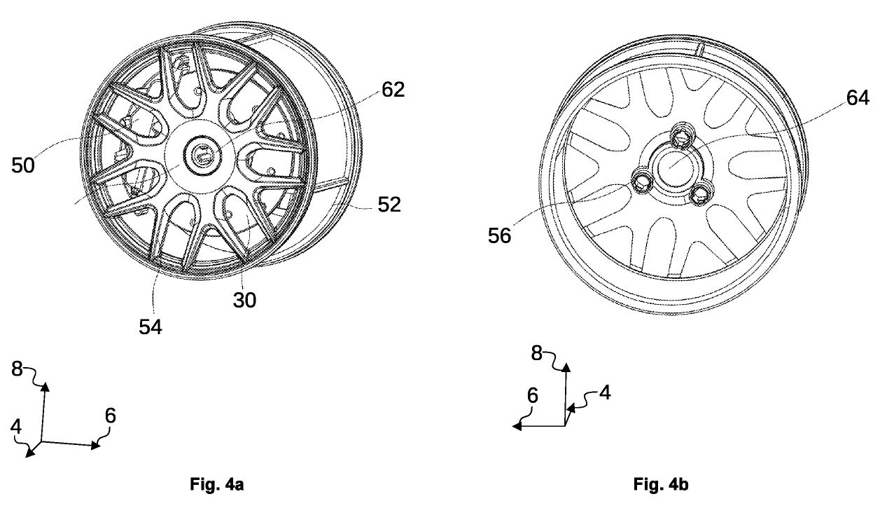

In FIG. 1, the wheels 13 are held directly on the wheel axles 14, which proves to be unsuitable in particular for motorized interlocking building block models 2 or for those in which functional details – for example the brake system – are to be represented as realistically as possible. For this reason, an alternative wheel assembly 22 is described below, which is explained in more detail with reference to FIGS. 2a and 2b.

The wheel assembly 22 comprises one of the wheels 13, which is configured for mounting on a first interlocking building block 23 with a hub flange 24. The wheel 13 is formed hollow-cylindrically and is open at one end face so that it can be pushed onto the hub flange 24.

The hub flange 24 is formed rotationally symmetrically about a rotational axis 26 of the wheel assembly 22 and has on its end face facing the wheel 13 several – in the present embodiment six – receptacle openings 28 which are distributed uniformly in the circumference about the rotational axis 26. The receptacle openings 28 are arranged in a common radial plane and serve, as described in more detail below, for the form-fit transmission of a torque acting about the rotational axis 26 between the hub flange 24 and the wheel 13.

The uniform, rotationally symmetrical arrangement of the receptacle openings 28 permits an assembly-friendly and tolerance-insensitive connection, since the wheel 13 can be placed on in several relative positions with respect to the axis without a defined alignment position being required. Moreover, the multiple distribution of the receptacle openings ensures a uniform introduction of force and thus a high continuous load capacity of the connection.

On the rear side of the hub flange 24 facing away from the wheel 13, a brake disc 30 adjoins, which lies coaxially to the rotational axis 26 and is connected in a rotationally fixed manner to the hub flange 24. According to FIG. 2a, the brake disc 30 is provided with several distortion recesses which serve the stylized representation of cooling air openings of real brake discs.

Concentrically to the hub flange 24, a pin receptacle 32 is guided, on the outer surface of which two – as seen in the circumferential direction – rotationally symmetrically arranged bayonet grooves 34 are formed. These are discussed in more detail below. The pin receptacle 32 is embedded in a receptacle tube 38 which on the side facing the wheel 13 is radially enclosed by the receptacle openings 28 and on the opposite side – beyond the brake disc 30 – is formed as a tube extension. At its rear end, a universal joint partner 40 for coupling to a drive element is integrally formed.

The universal joint partner 40 is guided through a bearing opening 42 of a wheel bearing 44 so that the receptacle tube 38 is rotatably mounted in the bearing opening 42 in the assembled state. On the wheel bearing 44, ball joint receptacles 46 are formed which enable a rotatable mounting of the wheel bearing 44 for simulating a steering function. Via force transmission elements 48 fastened in a manner known per se, steering forces can be introduced which pivot the wheel bearing 44 about the ball joint receptacles 46. In this context, the universal joint provides flexible transmission of drive forces with simultaneous mobility.

For further functional modeling, a brake caliper 50 can be fastened to the wheel bearing 44; its exact configuration, however, is not relevant for understanding the present embodiment.

As already stated above, the receptacle openings 28 are arranged in a common radial plane and are provided for torque transmission between the hub flange 24 and the wheel 13. For this purpose, the wheel 13 has a wheel rim 52 which is closed at the end face – axially opposite the hub flange 24 – by a cover plate 54. The cover plate 54 is provided with several through openings not further referenced, through which stylized spokes are modeled. On the side facing the hub flange 24, several torque transmission pins 56 are held on the cover plate 54 radially in a common plane and at equidistant circumferential spacings about the rotational axis 26. These can be inserted axially into the corresponding receptacle openings 28. The torque transmission pins 56 can in principle be formed in analogy to LEGO Technic pins, for example according to part number 2780, and can latch there – if desired. A latching or clamping is not required for the function of torque transmission; a form-fit engagement is sufficient.

Independently of the torque transmission, the wheel 13 is axially fastened to the hub flange 24 via a securing pin 58 on the interlocking building block 23. The securing pin 58 comprises a hollow tube 59 with a first end insertable into the pin receptacle 32, which is provided with two radially projecting bayonet lugs 60 arranged rotationally symmetrically to the rotational axis 26. At the second end of the hollow tube 59 opposite the first end, a fixing flange 62 is formed. Not all bayonet lugs 60 are provided with reference signs separately in the figures.

For axial securing of the wheel 13 on the hub flange 24, the securing pin 58 is passed through a central receptacle opening 64. The bayonet lugs 60 are inserted into the bayonet grooves 34 of the pin receptacle 32 and displaced axially in the direction of the universal joint 40. As soon as the fixing flange 62 rests against the cover plate 54 of the wheel 13, the securing pin 58 is rotated about the rotational axis 26 so that the bayonet lugs 60 come to rest on radially inwardly located retaining shoulders 66 in the receptacle tube 38 and the securing pin 58 can no longer be pulled axially out of the pin receptacle 32. The wheel 13 is thus axially secured on the hub flange 24.

For visual support during insertion and rotation of the securing pin 58, radial windows 68 are provided in the receptacle tube 38, through which the position of the bayonet lugs 60 is visible.

The securing pin 58 can in principle be rotated in any desired manner. Preferably, however, tool receptacles 70 are formed in the interior of the hollow tube 59, which act as form-fit elements acting in the circumferential direction and enable the application of an auxiliary tool for rotation.

1. Interlocking building block (23) for holding a wheel (13) in an interlocking building block model (2), comprising:
a hub flange (24) rotatable about a rotational axis (26) with a front side as seen in the direction of the rotational axis (26) and a rear side opposite the front side,
wherein on the front side, radially spaced from the rotational axis (26), at least two form-fit elements (56, 28) acting in the circumferential direction about the rotational axis (26) for transmitting a torque acting about the rotational axis (26) to the wheel (13) are held, and
a hub pin (38) held on the rear side concentrically to the rotational axis (26) on the hub flange (24) for mounting the hub flange (24) on a wheel suspension (44),
characterized by
a bearing element (32) independent of the form-fit elements (56, 28) for axially holding a retaining means (58) which is configured to block an axial movement between the wheel (13) and the hub flange (24).

2. Interlocking building block (23) according to claim 1, wherein the bearing element (32) is formed as a pin receptacle (32) for receiving the retaining means (58) in the form of a securing pin (58) from the front side toward the rear side.

3. Interlocking building block (23) according to claim 2, wherein the pin receptacle (32) has, at an end directed toward the rear side, a retaining shoulder (66) on which an axially acting locking element (60) of the securing pin (58) can be supported.

4. Interlocking building block (23) according to claim 3, wherein the locking element (60) is formed as a bayonet lug (60) that can be axially supported on the retaining shoulder (66), and the pin receptacle (32) has a bayonet groove (34) for guiding the bayonet lug (60).

5. Interlocking building block (23) according to claim 3, wherein the pin receptacle (32) is formed in sections in a tubular manner (38) with a radial window (68) in the region of the retaining shoulder (66).

6. Interlocking building block (23) according to claim 1, wherein the bearing element (32) is arranged concentrically to the rotational axis (26).

7. Interlocking building block (58) for blocking an axial movement between a wheel (13) and a hub flange (24), rotatable about a rotational axis (26), of a further interlocking building block according to claim 1, comprising:
a shaft (59) alignable parallel to the rotational axis (26) with a first end and a second end opposite the first end,
a first axially acting form-fit element (62) formed at the first end for blocking the axial movement of the wheel (13) relative to the shaft (59), and
a second axially acting and radially rigid form-fit element (60) formed at the second end for blocking the axial movement of the shaft (59) relative to the hub flange (24).

8. Interlocking building block (58) according to claim 7,
characterized in that the shaft (59) is formed as a hollow shaft (59) with form-fit elements (70) acting in the circumferential direction and held therein.

9. Interlocking building block (58) according to claim 7,
characterized in that the shaft (59) has, toward the second end and below the first axially acting form-fit element (62), a stop shoulder (not separately referenced).

10. Interlocking building block model (2) comprising a vehicle chassis (12) on which a wheel bearing (44) is held, wherein on the wheel bearing (44) an interlocking building block (23) is held, and wherein on the interlocking building block (23) a wheel (13) is held and axially fixed by means of a further interlocking building block (58) according to claim 7;
wherein the interlocking building block (23) comprises:
the hub flange (24) rotatable about the rotational axis (26) with the front side as seen in the direction of the rotational axis (26) and the rear side opposite the front side,
wherein on the front side, radially spaced from the rotational axis (26), the at least two form-fit elements (56, 28) acting in the circumferential direction about the rotational axis (26) for transmitting the torque acting about the rotational axis (26) to the wheel (13) are held, and
the hub pin (38) held on the rear side concentrically to the rotational axis (26) on the hub flange (24) for mounting the hub flange (24) on the wheel suspension (44),
characterized by
the bearing element (32) independent of the form-fit elements (56, 28) for axially holding the retaining means (58) which is configured to block an axial movement between the wheel (13) and the hub flange (24).
